(19) United States
(12) Patent Application Publication
(10) Pub. No.: US 2025/0186958 A1
(43) Pub. Date: Jun. 12, 2025

(54) FIXED BED GASIFIER WITH ROLLERS

(71) Applicant: MHR HOLDING PTE. LTD., Singapur (SG)

(72) Inventors: Michael Hofmeister, Dresden (DE); Horst Dressler, Muehlhausen (DE)

(21) Appl. No.: 18/845,969

(22) PCT Filed: Mar. 2, 2023
(86) PCT No.: PCT/IB2023/051942

§ 371 Date: Sep. 11, 2024

(30) Foreign Application Priority Data
Mar. 16, 2022 (DE) 10 2022 106 170.1

(51) Int. Cl. B01J 8/00; B01J 8/02; C01B 3/02; C10J 3/32

(52) U.S. Cl. CPC B01J 8/002; B01J 8/0278; B01J 8/0285; C01B 3/02; C10J 3/32; B01J 2208/00176; B01J 2208/00761

(57) ABSTRACT

A fixed bed gasifier generates a producer or synthesis gas of a solid fuel, particularly of slagging fuel. The gasifier includes a gasifier tank, a fuel supply for supplying solid fuel, and at least one gasification agent supply for supplying at least one gasification agent that is used to gasify the solid fuel provided in the tank. An outlet discharges slag and producer and synthesis gas which result from the gasification of the solid fuel. At least two rollers are arranged beneath or downstream of the gasifier tank and counter-rotate about their roller longitudinal axis for conveying residues remaining from the gasification of the fuel, particularly carbonaceous ash and slag, out of the fixed bed gasifier. The distance between the two longitudinal roller axes is at least as large as the width or the diameter of the outlet of the gasifier tank.

### CROSS-REFERENCE TO RELATED APPLICATIONS

This application is the United States national stage entry of International Application No. PCT/IB2023/051942, filed on Mar. 2, 2023, and claims priority to German Application No. 10 2022 106 170.1, filed on Mar. 16, 2022. The contents of International Application No. PCT/IB2023/051942 and German Application No. 10 2022 106 170.1 are incorporated by reference herein in their entireties.

### FIELD

The present disclosure relates to a fixed bed gasifier for generating a producer or synthesis gas from solid fuel, in particular from slagging fuel, comprising a, specifically cylindrical, gasifier tank. The gasifier tank includes a fuel supply for supplying a solid fuel, a gasification agent supply for supplying a gasification agent which is used to gasify the solid fuel provided in the tank, and an outlet for discharging slag and ash and producer and synthesis gas produced during gasification of the solid fuel.

### BACKGROUND

In the fixed bed gasifier, (bulk) fuel, specifically biomass, in a solid state (solid fuel), usually wood or coal, sewage sludge, but also biomass-type and other secondary fuels, as well as a proportion of domestic waste/plastic fractions, is converted thermochemically to a combustible producer or synthesis gas (fuel gas) with the aid of a gasification or oxidation agent, in particular air, oxygen, carbon dioxide or steam. The solid fuel can be converted, via the gasification in the fixed bed gasifier, to a gaseous secondary fuel or to a producer gas which can be used, for example, in electricity generation or as fuel and propellant (fuel gas) or for use as synthesis gas for chemical synthesis.

The fixed bed gasifier or, resp., the gasifier tank is divided into different adjacent temperature zones in its height direction or axial direction, respectively. The temperature zone closest to the opening is a drying zone in which the water contained in the solid fuel is evaporated at a drying temperature. A pyrolysis zone adjoins the drying zone in the height direction below the latter. In the pyrolysis zone, the solid fuel is disintegrated at a pyrolysis temperature. An oxidation zone adjoins the pyrolysis zone in the height direction below the latter. In the oxidation zone, the carbon (C) and hydrogen (H) contained in the disintegrated solid fuel are oxidized into carbon dioxide (CO₂) and into water (H₂O) at an oxidation temperature. A reduction zone adjoins the oxidation zone in the height direction below the latter. In the reduction zone, the carbon dioxide (CO₂) and, resp., the water (H₂O) obtained from the oxidation zone are reduced at a reduction temperature into the combustible producer or synthesis gas as a product of fixed bed gasification. In the fixed bed gasifier, the drying temperature is lower than the pyrolysis temperature which, in turn, is lower than the oxidation temperature which, in turn, is higher than the reduction temperature. Carbonaceous ash remains as a solid component of the gasified solid fuel.

Furthermore, fixed bed gasifiers can be used to gasify, as a fuel, a slagging fuel or biomass, specifically biological residues, preferably waste material, further preferably sewage sludge. The gasification of those slagging fuels, specifically of sewage sludge, is used for the environmentally friendly disposal of said materials.

In fixed bed gasification, in particular in cases in which slagging fuels such as waste materials are used as biomass to be gasified, the slag and carbonaceous ash resulting from the gasification as gasification residue is particularly difficult to remove from the fixed bed gasifier. In conventional fixed bed gasifiers, a horizontally arranged grid is provided as a support device below the outlet of the gasifier tank inside the fixed bed gasifier. This is known, for example, from DE 10 2019 218 310 A1. The slag and ash leaving the gasifier tank are supplied through the grid-shaped support device to an ash and gas flue through which the gasification residues as well as the gas generated during gasification can leave the fixed bed gasifier. However, the slag sometimes forms lumps and, therefore, the grid-shaped support device may not be capable of conveying the slag and ash evenly out of the gasifier tank. As a result, slag and, possibly, ash may collect on the grid and, consequently, the gasification in the fixed bed gasifier may be impaired or may come to a complete standstill.

Against this background, in DE 10 2019 218 310 A1 two counter-rotating rollers were suggested as support device. The problem in this case is, however, that the rollers as support device possibly push the gasification residues, particularly slag, back into the gasifier tank. This impairs the gasification in the gasifier tank enormously.

### SUMMARY

Accordingly, it is an object of the present disclosure to provide a fixed bed gasifier that achieves the above-described object. In particular, it is intended to provide a fixed bed gasifier in which reliable gasification is ensured. Preferably, a fixed bed gasifier is to be provided in which gasification residues, particularly slag and carbonaceous ash, are conveyed evenly out of the fixed bed gasifier and the gasification residues are prevented from being pushed back into the gasifier tank.

Consequently, the present disclosure relates to a fixed bed gasifier for generating a producer or synthesis gas of solid fuels, particularly of slagging fuels, comprising a, specifically cylindrical, gasifier tank. The gasifier tank has a fuel supply for supplying a solid fuel, one or more gasification agent supply/supplies, particularly exactly two gasification agent supplies, for supplying one or more gasification agent(s) which is/are used to gasify the solid fuel present in the tank, and an outlet for discharging slag, carbonaceous ash and producer and synthesis gas which are formed during gasification of the solid fuel. Beneath or downstream of the gasifier tank and, resp., the outlet of the gasifier tank, at least two rollers are arranged for conveying residues, particularly carbonaceous ash and slag, remaining from the gasification of the fuel out of the fixed bed gasifier, which rollers rotate, preferably intermittently, in opposite directions about their longitudinal roller axis, wherein the center distance between the two longitudinal roller axes is at least as large as the width or the diameter of the outlet of the gasifier tank.

By means of the counterrotating rollers, the gasification residues can be removed very efficiently and free from residues from the gasifier tank and, resp., from the fixed bed gasifier. As the rollers rotate in opposite directions, a particularly large amount of material can be conveyed out of the fixed bed gasifier. If the center distance between the two longitudinal roller axes is at least as large as the diameter, preferably the inner diameter, of the (outlet of the) gasifier tank, it can be ensured that the material column (of ash and slag) is discharged (downwards) through the rollers out of the gasifier tank and is not pushed back (upwards) into the gasifier tank.

Advantageous aspects of the present disclosure shall be explained in detail in the following.

Particularly preferred, the rollers rotate, as seen from the side of the outlet of the gasifier tank, inwardly, i.e., toward each other, and away from the outlet of the gasifier tank.

With such direction of rotation of the rollers, gasification residues can be prevented very efficiently from being pushed back into the gasifier tank by the rollers.

In particular, the rollers are arranged to be axially symmetrical to a central longitudinal axis of the gasifier tank. Thus, the gasification residues can be conveyed particularly evenly and, thus, efficiently.

It is furthermore particularly reasonable when the longitudinal roller axes are arranged horizontally and moreover perpendicularly to the longitudinal axis of the gasifier tank. In this way, the rollers are excellently suited for conveying slag.

This allows even discharge of material from the outlet of the gasifier tank. Thus, homogenous bulk conditions are provided in the filling until the gasification residues are discharged. Consequently, the material to be discharged moves only to the center of the gasifier tank where it is then discharged through the outlet from the fixed bed gasifier, and does not accumulate at one point. Thus, the material to be discharged does not move in the direction of the gasifier tank (upwards), either. Fine and coarse particles of the gasification residues are conveyed or discharged proportional to the roller speed. This facilitates smooth continuous operation of the fixed bed gasifier and a good gas quality of the producer gas.

Advantageously, the rollers are provided to be supported via hollow shafts in which a coolant, particularly water or oil, is passed for cooling the rollers.

By means of said hollow shaft cooling, the rollers can be sufficiently cooled. The cooling of the rollers is necessary so that the rollers or elements arranged on the same do not bend due to the heat transferred to them by the slag and ash. Accordingly, the coal produced as residue during gasification which is deposited in layers around the rollers as a bad heat conductor acts as an insulator against the slag having a temperature of up to 1000°° C. which impacts on the rollers. Therefore, cooling of the rollers via the hollow shafts is sufficient despite the high temperatures of the gasification residues.

The rollers can be cooled via evaporation cooling or via conductive water or oil cooling. In the case of evaporation cooling just as in the case of water or oil cooling, a liquid is passed in the hollow shafts of the rollers. In the water or oil cooling as well as in the evaporation cooling, the coolant is heated when it flows through the hollow shafts. Then the heated water, and thus also the heat generated at the rollers, is drained. In the evaporation cooling, additionally hot steam formed due to the high temperature of the heated liquid coolant, specifically water, is discharged, specifically pumped, by the coolant. In so doing, the steam (without soot particles) is passed upwards (in the direction of the gasifier tank) while being cooled. The cooling system in which the coolant is passed and circulated is a closed system which is not fluid-connected to the gasifier. A coolant receiver tank in which coolant is received is located above the rollers so that a natural circulation is ensured.

In this way, the rollers can be cooled efficiently and without great effort.

Moreover, it is of advantage when the rollers, and specifically teeth arranged on the rollers, and/or disks of the rollers including the teeth, are manufactured of hardened steel, in particular a steel marketed under the registered trademark HARDOX®.

Said material does not deform despite the heat to which the rollers are exposed, and in addition sufficient heat can be guided or passed from the outer periphery of the rollers which is mainly in contact with the hot gasification residues to the centrally arranged hollow shafts.

Moreover, it is conceivable that each of the rollers includes a plurality of circular disk- shaped roller disks connected for rotation with each other and some of the roller disks are provided with teeth meshing with the teeth of the counterrotating roller at their outer periphery.

The number of the roller disks can be easily varied and, thus, thanks to the modular roller structure, rollers of different length can be provided in a simple manner. As the teeth of the counterrotating rollers are in mesh with one another, the material to be discharged can be conveyed out of the gasifier tank and thus out of the fixed bed gasifier particularly well by the rollers. The teeth of the rollers advantageously crush slag lumps so that they can be easily conveyed. With the aid of the above-mentioned hollow shaft cooling, the teeth are prevented from bending due to high temperatures.

In particular, teeth of a first tooth size can be provided to be arranged alternately with teeth of a second tooth size which is different from the first tooth size over the outer periphery of the roller disks.

Due to the different tooth sizes of the rollers, slag lumps can be caught and crushed very efficiently and thus can be conveyed out of the gasifier tank and, resp., the fixed bed gasifier by the rollers.

It is further conceivable that the teeth of the first tooth size of one roller mesh with the teeth of the first tooth size of the roller counterrotating relative to the one roller and the teeth of the second tooth size of one roller mesh with the teeth of the second tooth size of the roller counterrotating relative to the one roller.

Thus, between the teeth of the first tooth size which are larger than the teeth of the second tooth size, for example, smaller slag lumps can be caught and crushed than between the (smaller) teeth of the second tooth size. Consequently, can be ensured that slag lumps of different sizes can be caught and crushed efficiently by the roller teeth.

It is also reasonable when the roller disks are divided into roller disks having teeth and plain roller disks having no teeth, and the roller disks having teeth are arranged alternately with plain roller disks successively in the roller longitudinal direction.

Rollers in which only every second roller disk is provided with teeth are cheaper in manufacture and are easier to clean than rollers in which all roller disks are provided with teeth.

The roller disks with teeth advantageously are larger, regarding their dimension and their overall diameter, than the plain roller disks by the teeth.

A preferred aspect relates to the fact that the plain roller disks of a roller contact the respective roller disks with teeth of the counterrotating roller and that the teeth of the counterrotating rollers mesh in the longitudinal direction of the rollers.

In this way, the teeth of the one roller can remove gasification residues from the plain roller disks of the other, counterrotating roller. In this way, the two counterrotating rollers mutually clean each other (automatically).

It is further advantageous when the teeth of the rollers are arranged spirally or helically relative to the longitudinal axis of the rollers. In this way, only one pair of teeth of the pair of rollers at a time meshes with each other. Thus, the drive power for the rollers and the strain on a roller bearing and, consequently, on the hollow shafts advantageously can be minimized.

In the generic fixed bed gasifier, each of the rollers has a plurality of circular disk-shaped roller disks connected for rotation with each other. The roller disks are divided into roller disks with teeth and plain roller disks without teeth, and the roller disks with teeth are arranged alternately with plain roller disks successively in the longitudinal direction of the rollers. The plain roller disks of one roller are opposed to the respective roller disks with teeth of another (adjacent) counterrotating roller, and vice versa. In this way, the teeth of the one roller can remove gasification residues from the plain roller disks of the other roller counterrotating with the former. Consequently, the two counterrotating rollers mutually clean each other (automatically) and gasification residues, specifically slag and ash, are conveyed evenly out of the fixed bed gasifier.

It is also conceivable that two counterrotating rollers form a pair of rollers and the fixed bed gasifier includes more than one pair of rollers, in particular two pairs of rollers.

If the fixed bed gasifier includes more than one pair of rollers, a particularly large volume of gasification residues can be conveyed out of the gasifier tank and, resp., out of the fixed bed gasifier. Consequently, also more starting material (fuel) can be gasified in the gasifier tank.

### BRIEF DESCRIPTION OF THE DRAWINGS

FIG. 1 is a schematic longitudinal section view of a fixed bed gasifier;

FIG. 2 is a schematic longitudinal section view of a gasifier insert;

FIG. 3 is a schematic top view onto two rollers;

FIG. 4 is a schematic longitudinal section view of two rollers arranged side by side; and

FIG. 5 is a simplified schematic longitudinal section view of a fixed bed gasifier having more than two rollers.

### DETAILED DESCRIPTION

Hereinafter, aspects of the present disclosure shall be described based on the related Figures. The shown aspects are merely exemplary and can be combined with each other, as far as this is technically reasonable.

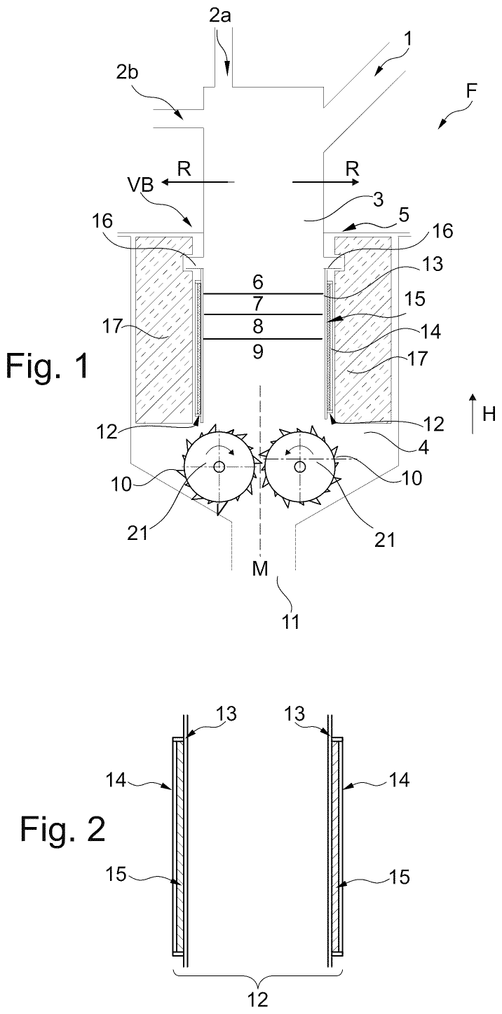

FIG. 1 is a schematic longitudinal section view of a fixed bed gasifier F. The fixed bed gasifier F described below is particularly suited to gasify slagging solid fuels, specifically waste materials, such as sewage sludge. The fixed bed gasifier F includes a gasifier tank VB. The gasifier tank VB includes, in its top section as seen in the axial direction or height direction H, a fuel supply 1 as well as a primary gasification agent supply 2a and a secondary gasification agent supply 2b. The (solid) fuel to be gasified, specifically slagging fuel, is supplied to the gasifier tank VB via the fuel supply 1. A gasification agent such as air, oxygen, steam or carbon dioxide is supplied to the gasifier tank VB of the fixed bed gasifier F via the gasification agent supplies 2a, 2b. The gasifier tank VB includes a chute 3 to the top section of which the fuel supply 1 and the gasification agent supplies 2a, 2b are attached in a height direction H. The chute 3 opens with its bottom section into a, specifically pressure-tight, gasifier casing 4. The chute 3 has a hollow-cylindrical design.

The primary gasification agent supply 2a is used in each mode of operation of the fixed bed gasifier F. The secondary gasification agent supply 2b is used when the system is run with oxygen and steam/carbon dioxide. The pressure-tight gasifier casing 4 has a substantially hollow-cylindrical design. On its upper side (top side of the gasifier casing 4 in the height direction H), the gasifier casing 4 has an opening 5 through which the chute 3 is connected to the gasifier casing 4. The upper part of the fixed bed gasifier F, i.e., the chute 3 with the fuel supply 1 and the primary gasification agent supply 2a as well as the secondary gasification agent supply 2b, forms a flange 5 and is flanged to the gasifier casing 4. The flanged connection between the upper part of the fixed bed gasifier F and the gasifier casing 4 is sealed gas-tightly to the environment so that no gas can escape from the fixed bed gasifier F between the upper part of the fixed bed gasifier F and the gasifier casing 4.

Different temperature zones 6 to 9 successive in the height direction H inside the gasifier casing 4 are provided in the gasifier tank VB that protrudes into the gasifier casing 4. The top temperature zone as viewed in the height direction H of the fixed bed gasifier F is the drying zone 6. At a drying temperature of about 100° C., the water contained in the fuel is evaporated here. The pyrolysis zone 7 in which the fuel is disintegrated at a pyrolysis temperature of up to 250° C. adjoins underneath. The oxidation zone 8 in which carbon and hydrogen occurring in the fuel are oxidized into carbon dioxide and water at an oxidation temperature of up to 1700° C. (see above) adjoins beneath the pyrolysis zone 7. The reduction zone 9 as the bottom section of the gasifier tank VB in which the carbon dioxide and water obtained in the oxidation zone 6 are reduced at a reduction temperature ranging from 600°° C. to 800° C. adjoins beneath the oxidation zone 8. After the reduction, the finished product, i.e., a producer or synthesis gas, is provided.

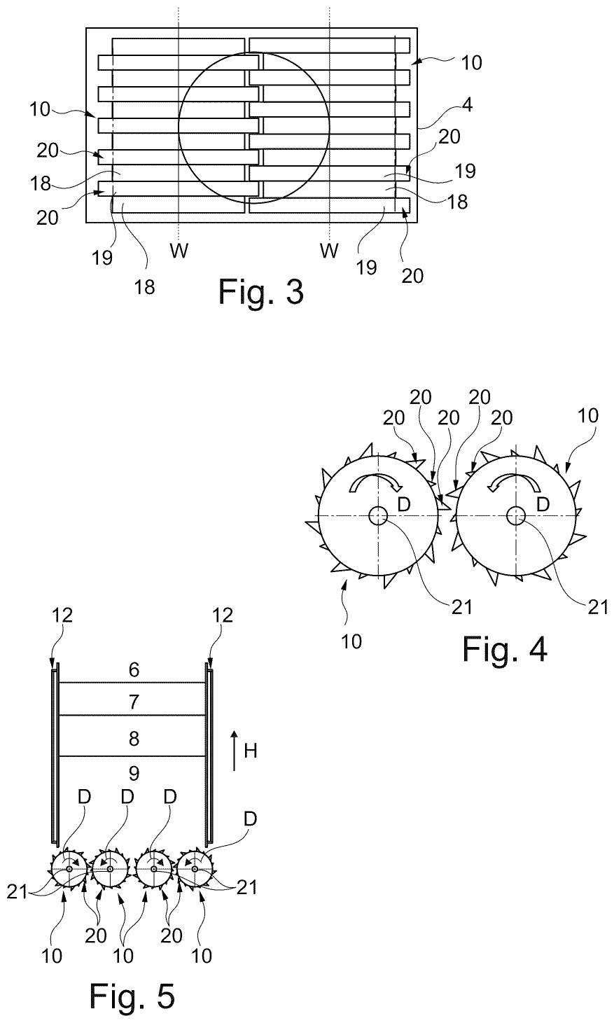

Carbonaceous ash and slag remain as a solid residue of the gasification in the temperature zones 6 to 9 in the fixed bed gasifier F. They are drained into the gasifier casing 4 through an outlet at the gasifier tank VB (bottom section of the gasifier tank VB in the height direction H) which is arranged inside the gasifier casing 4. In order to discharge said solid residues from the gasifier casing 4 and to ensure homogenous bulk conditions in the gasifier casing 4, the solid residues are conveyed into an ash and gas flue 11 with the aid of at least two counterrotating rollers 10 (described in detail with respect to FIG. 3 to FIG. 5) which are arranged in a lower section (as viewed in the height direction H) of the gasifier casing 4. The gasifier casing 4 is conically tapered toward the ash and gas flue 11. The solid residues as well as the producer gas obtained are discharged from the fixed bed gasifier F through the ash and gas flue 11.

The section of the gasifier tank VB in which the temperature zones 6 to 9 are provided is designed in this case as a gasifier insert 12 formed separately from the chute 3. The gasifier insert 12 is arranged inside the gasifier casing 4 and extends in the height direction H. The gasifier insert 12, just as the chute 3, has a hollow cylinder shape. The diameter, specifically the inner diameter, of the gasifier insert 12 advantageously corresponds to the diameter, preferably the inner diameter, of the chute 3. The gasifier insert 12 limits the diameter of the temperature zones 6 to 9 to its own inner diameter.

The side of the gasifier insert 12 facing a central longitudinal axis M of the gasifier tank VB which forms at least a section of the tank wall of the gasifier tank VB is referred to as inner casing 13. The inner casing 13 is advantageously made of stainless steel. Together with an outer casing 14 that is spaced in parallel from the inner casing 13, the inner casing 13 encloses a temperature homogenizing layer 15. Advantageously, the outer casing 14 is also made of (stable) stainless steel. In particular, copper is used as temperature homogenizing layer 15. The copper ensures that the temperature is optimally distributed homogenously in the height direction H and in the circumferential direction of the gasifier tank VB.

The gasifier insert 12, and specifically the top section thereof in the height direction H, is connected to the chute 3, in particular to the bottom section thereof in the height direction H, using a holder 16. The holder 16 is a type of flange that is flanged to the gasifier insert. An insulating plate may be arranged as a sealing for the two flanges. The gasifier insert 12 is thermally insulated from the chute 3 by said insulating plate. Further, a temperature insulating layer 17 is provided between the outer casing 14 and the inner wall of the gasifier casing 14. The temperature insulating layer 17 intensifies the effect of the temperature homogenization and, resp., of the even distribution of the temperature inherent to the gasifier insert 12 and, thus, the decrease or suppression of temperature gradients inside the gasifier tank VB and, resp., the gasifier insert 12. The temperature insulating layer 17 is hollow-cylindrical and surrounds the gasifier insert 12 from outside.

FIG. 2 is a schematic longitudinal section view of the gasifier insert 12. It is clearly visible in which way the temperature homogenizing layer 15 is enclosed and, resp., encompassed by the inner casing 13 and the outer casing 14. The temperature homogenizing layer 15 can possibly melt or liquefy at extremely high temperatures (from about 1085° C. for copper). Since temperatures of up to 1700° C. occur in the fixed bed gasifier F, it may thus happen that the copper melts. Enclosing the temperature homogenizing layer 15 by the inner casing 13 and the outer casing 14 prevents the temperature homogenizing layer 15 from “flowing off”.

FIG. 3 is a schematic top view onto two engaging rollers 10 which are arranged in the gasifier casing 4, particularly directly, below the outlet of the gasifier tank VB. With the aid of the rollers 10, fine and coarse ash and slag particles are conveyed axially symmetrically and in proportion to a roller speed. The rollers 10 thus support smooth continuous operation of the fixed bed gasifier F and a gas of good quality (gas with little or no contamination). The center distance AA between the two roller longitudinal axes W of the rollers 10 corresponds at least to the diameter DM of the gasifier insert 12.

The rollers 10 are composed of a plurality of annular roller disks 18, 19. The annular roller disks 18, 19 are arranged successively along the longitudinal axis W of the rollers and are connected for rotation and, resp., integrally with each other. Roller disks 18 having a plain outer periphery alternate with roller disks 19 having teeth 20 distributed over their outer periphery. The diameter of the roller disks 19 with teeth 20 is larger than that of the plain roller disks 18 by the teeth 20. The plain or toothless roller disks 18 of one roller 10 contact the respective roller disks 19 with teeth 20 of the other roller 10 arranged beside it. In this way, the two rollers 10 arranged side by side mutually clean each other. In so doing, at least one tooth 20 meshes with the corresponding tooth 20 of the adjacent roller 10 in the roller longitudinal direction.

FIG. 4 illustrates, just as FIG. 1, a longitudinal section view of two engaging and counterrotating rollers 10 which rotate toward each other at the top (on the side of the gasifier insert) and, thus, form a pair of rollers. The arrow D in the respective roller 10 indicates the direction of rotation thereof. It is evident that the rollers 10 rotate toward each other. Accordingly, the rollers 10 rotate away from the outlet of the gasifier tank VB (see FIG. 1). The teeth 20 of the interacting rollers 10 of one pair of rollers engage and mesh with each other. As a result, the teeth 20 catch and crush lump-shaped slag. The teeth 20 of one roller disk 19 are different in size and are divided into teeth 20 and smaller teeth 20 which are smaller than the teeth 20. Accordingly, the teeth 20 mutually alternate with the smaller teeth 20 over the outer periphery of the respective roller disk 19. The rollers 10 are arranged and aligned relative to each other so that each tooth 20 of one roller 10 meshes or interacts with a tooth 20 of the other roller 10 of the pair of rollers arranged beside it and each smaller tooth 20 of the one roller 10 meshes or interacts with a smaller tooth 20 of the other roller 10 of the pair of rollers arranged beside it. In particular, the longitudinal axes W of the two rollers 10, 10 arranged side by side are parallel to each other. Moreover, the teeth 20 are arranged on the roller disks 19 spirally or helically relative to the respective roller longitudinal axis W. This has the effect that only one pair of teeth 20 of the pair of rollers is in mesh at a time. Advantageously, the drive power for the rollers 10 and the strain on a roller bearing can thus be minimized.

Furthermore, the rollers 10 can reach very high temperatures, as the ash and slag conveyed by them has temperatures of up to 1000° C. It is therefore necessary to cool the rollers 10. Accordingly, the rollers 10 are arranged on hollow shafts 21 for cooling. A coolant, particularly water or oil, flows through the hollow shafts 21 to cool the rollers 10. This type of cooling allows inexpensive and simple packings and bearings, specifically radial shaft seal rings, to be used in the fixed bed gasifier F. Advantageously, the coolant which flows past the hot rollers 10 for cooling and, thus, is heated can be used to dry the solid fuel. It is particularly useful to dry the solid fuel by means of the heat from the heated coolant outside the fixed bed gasifier F.

Taking the ratio of the center distance of the rollers to the inner diameter of the gasifier insert 12 into account, the fixed bed gasifier F can be scaled.

FIG. 5 is a simplified schematic longitudinal section view of the fixed bed gasifier F comprising four rollers 10 arranged side by side. For convenience, only the gasifier insert 12 as well as the temperature zones 6 to 9 occurring inside the gasifier insert 12 are shown here. Beneath the gasifier insert 12, four rollers 10 are arranged at one level in the height direction H. The center distance of the two outermost rollers 10 corresponds at least to the inner diameter of the gasifier insert 12. Each roller 10 counterrotates relative to the roller(s) 10 arranged next to it. Accordingly, each of the outer rollers 10 and the inner rollers 10 arranged directly next to it form a respective pair of rollers. In case that more than one pair of rollers is provided in the fixed bed gasifier F, the rollers 10 are smaller and have a larger distance from the oxidation zone 8 and, resp., from the reduction zone 9 than compared to a fixed bed gasifier F which includes one pair of rollers only. In this way, also a fixed bed gasifier F having more than one pair of rollers can convey the (carbonaceous) ash and slag produced during gasification out of the gasifier tank VB and, resp., can convey said material downwards to the outlet. The rollers 10 of one pair of rollers rotate toward each other. The inner rollers 10 of the respective different pairs of rollers rotate away from each other. The rollers 10 are designed as illustrated in FIGS. 3 and 4 and are arranged so that the roller disks 18 without teeth of one roller in each case are opposite to the roller disks 19 with teeth of another (adjacent) counterrotating roller, and vice versa.

### LIST OF REFERENCE SIGNS

1 Fuel supply
2a primary gasification agent supply
2b secondary gasification agent supply
3 chute
4 gasifier casing
5 opening
6 drying zone
7 pyrolysis zone
8 oxidation zone
9 reduction zone
10 roller
11 ash and gas flue
12 gasifier insert
13 inner casing
14 outer casing
15 temperature homogenizing layer
16 holder
17 temperature insulating layer
18 plain roller disk
19 roller disk with teeth
20 teeth
21 hollow shaft
AA center distance of the rollers
D direction of rotation of roller
DM diameter of the outlet of the gasifier tank
F fixed bed gasifier
H height direction
M central axis of gasifier tank
R radial direction
VB gasifier tank
W roller longitudinal axis

1. A fixed bed gasifier for generating a producer or synthesis gas of a solid fuel, the fixed bed gasifier comprising:
a gasifier tank;
a fuel supply for supplying a solid fuel;
at least one gasification agent supply for supplying at least one gasification agent that is used to gasify the solid fuel provided in the gasifier tank;
an outlet for discharging slag and the producer and synthesis gas which result from gasification of the solid fuel; and
at least two rollers arranged beneath or downstream of the gasifier tank, the at least two rollers each comprising a roller longitudinal axis and configured to counterrotate about the roller longitudinal axis for conveying residues remaining from gasification of the solid fuel out of the gasifier tank,
the at least two rollers configured to directly convey the residues, and
the at least two rollers meshing with each other and defining a center distance between the roller longitudinal axes, the center distance being at least as large as a width of or a diameter of the outlet of the gasifier tank (VB).

2. The fixed bed gasifier according to claim 1, wherein the at least two rollers are supported via hollow shafts in which a coolant is passed to cool the at least two rollers.

3. The fixed bed gasifier according to claim 1, wherein the at least two rollers are manufactured of hardened steel.

4. The fixed bed gasifier according to claim 1, wherein:
the at least two rollers comprise a first roller comprising first roller disks and a second roller comprising second roller disks, the second roller counter-rotating relative to the first roller,
at least some of the first roller disks have first teeth,
at least some of the second roller disks have second teeth, and
the first teeth mesh with the second teeth.

5. The fixed bed gasifier according to claim 4, wherein the first teeth and the second teeth each comprise teeth of a first tooth size distributed alternately with teeth of a second tooth size different from the first tooth size over outer peripheries of the first roller disks and of the second roller disks.

6. The fixed bed gasifier according to claim 5, wherein the teeth of the first tooth size on the first roller mesh with the teeth of the first tooth size on the second roller, and the teeth (20) of the second tooth size on the first roller (10) mesh with the teeth of the second tooth size on the second roller, the second roller counter-rotating relative to the first roller.

7. The fixed bed gasifier according to claim 4, wherein:
the first roller disks are divided into first roller disks comprising the first teeth and first roller disks without teeth, and
the second roller disks are divided into second roller disks comprising the second teeth and second roller disks without teeth,
the first roller disks comprising the first teeth being arranged alternately with the first roller disks without teeth in a first roller longitudinal direction, and
the second roller disks comprising the second teeth being arranged alternately with the second roller disks without teeth in a second roller longitudinal direction.

8. The fixed bed gasifier according to claim 7, wherein the first roller disks without teeth are arranged opposite to the second roller disks comprising the second teeth, and the first roller disks comprising the first teeth are arranged opposite the second roller disks without teeth.

9. The fixed bed gasifier according to claim 4, wherein:
the first roller defines a first roller longitudinal axis and the second roller defines a second roller longitudinal axis,
the first teeth are arranged spirally with respect to the first roller longitudinal axis, and
the second teeth are arranged spirally with respect to the second roller longitudinal axis.

10. A fixed bed gasifier for generating a producer or synthesis gas of a solid fuel, the fixed bed gasifier comprising:
a gasifier tank;
a fuel supply for supplying a solid fuel;
at least one gasification agent supply for supplying at least one gasification agent that is used to gasify the solid fuel provided in the gasifier tank;
an outlet for discharging slag and producer and synthesis gas which result from gasification of the solid fuel; and
at least two rollers comprising at least a first roller and a second roller arranged beneath or downstream of the gasifier tank, the at least two rollers each comprising a roller longitudinal axis and configured to counterrotate about the roller longitudinal axis for conveying residues remaining from gasification of the solid fuel out of the fixed bed gasifier,
each of the at least two rollers having a plurality of circular disk-shaped roller disks connected for rotation with each other;
the plurality of circular disk-shaped roller disks being divided into roller disks with teeth and plain roller disks without teeth,
the roller disks with teeth are being arranged alternately with the plain roller disks successively in the roller longitudinal direction; and
the plain roller disks of one of the first roller being opposite to the roller disks with teeth of the second roller, and the roller disks with teeth of the first roller being arranged opposite to the plain roller disks of the second roller.

11. The fixed bed gasifier according to claim 1, wherein the at least two rollers are arranged directly beneath the outlet.
